(19) United States
(12) Patent Application Publication
(10) Pub. No.: US 2009/0071280 A1
(43) Pub. Date: Mar. 19, 2009

(54) Geared electric motor

(75) Inventor: Atsushi Nakagawa, Toyohashi-city (JP)

Correspondence Address: POSZ LAW GROUP, PLC, 12040 SOUTH LAKES DRIVE, SUITE 101, RESTON, VA, 20191, US

(73) Assignee: ASMO CO., LTD., Kosai-city (JP)

(21) Appl. No.: 12/219,391

(22) Filed: Jul. 22, 2008

(30) Foreign Application Priority Data
Sep. 14, 2007 (JP) 2007-239073

(51) Int. Cl. F16H 1/16

(52) U.S. Cl. 74/425

(57) ABSTRACT

A housing is made of resin and receives a worm. A worm wheel is made of resin and is received in the housing to mesh with the worm. A support shaft includes a shaft portion and a boss portion. The shaft portion rotatably supports the worm wheel. The boss portion is made of metal and is fixed to the housing. The boss portion holds the shaft portion and includes a slidably engaging surface that slidably engages the worm wheel.

### CROSS REFERENCE TO RELATED APPLICATION

This application is based on and incorporates herein by reference Japanese Patent Application No. 2007-239073 filed on Sep. 14, 2007.

### BACKGROUND OF THE INVENTION

1. Field of the Invention

The present invention relates to a geared electric motor.

2. Description of Related Art

A geared electric motor is used as, for example, a drive source of a power window apparatus that drives a window glass of a door of a vehicle to open and close the same, or a drive source of a sunroof apparatus that drives a sunroof panel of the vehicle to open and close the same.

Japanese Unexamined Patent Publication No. H08-84456 discloses a geared electric motor, in which a worm wheel is meshed with a worm provided in a rotatable shaft of an armature to reduce a rotational speed of the rotatable shaft through the worm wheel. The rotation at the reduced rotational speed is transmitted from the worm wheel to an output shaft of the geared electric motor.

The worm wheel is received in a resin housing. In a conventional geared electric motor, a center portion of the worm wheel slidably engages the housing, so that the worm wheel is rotated at a predetermined location.

Here, the housing is made of resin, which includes glass fibers to reinforce the strength of the housing. In such a case, when the worm wheel made of resin is rotated, the worm wheel is rasped with the glass fibers contained in the housing, thereby resulting in wearing of the worm wheel.

In the case of Japanese Unexamined Patent Publication No. H08-84456, a slide washer is placed on the slidably engaging surface of the housing to support the worm wheel, so that the wearing of the worm wheel is limited or alleviated. However, in this motor, the slide washer needs to be provided.

### SUMMARY OF THE INVENTION

The present invention addresses the above disadvantage. Thus, it is an objective of the present invention to provide a geared electric motor, in which wearing of a worm wheel is limited or is alleviated without need for providing a washer to limit the wearing.

In order to achieve the objective of the present invention, there is provided a geared electric motor, which includes an armature, a worm, a housing, a worm wheel and a support shaft. The armature has a rotatable shaft, which is rotated upon energization of the armature. The worm is connected to the rotatable shaft. The housing is made of resin and receives the worm. The worm wheel is made of resin and is received in the housing to mesh with the worm. The support shaft includes a shaft portion and a boss portion. The shaft portion rotatably supports the worm wheel. The boss portion is made of metal and is fixed to the housing. The boss portion holds the shaft portion and includes a slidably engaging surface that slidably engages the worm wheel.

### BRIEF DESCRIPTION OF THE DRAWINGS

The invention, together with additional objectives, features and advantages thereof, will be best understood from the following description, the appended claims and the accompanying drawings in which:

FIG. 1 is a cross sectional view of a geared electric motor according to a first embodiment of the present invention taken along line I-I in FIG. 4;

FIG. 2 is an enlarged partial cross sectional view showing a boss portion of a center shaft of the geared electric motor according to the first embodiment;

FIG. 3 is an exploded view of the geared electric motor according to the first embodiment;

FIG. 4 is a partially fragmented plan view of the geared electric motor according to the first embodiment;

FIG. 5 is an enlarged partial cross sectional view showing a boss portion of a center shaft of a geared electric motor according to a second embodiment of the present invention; and

FIG. 6 is an enlarged perspective view showing the center shaft of the geared electric motor according to the second embodiment.

### DETAILED DESCRIPTION OF THE INVENTION

### First Embodiment

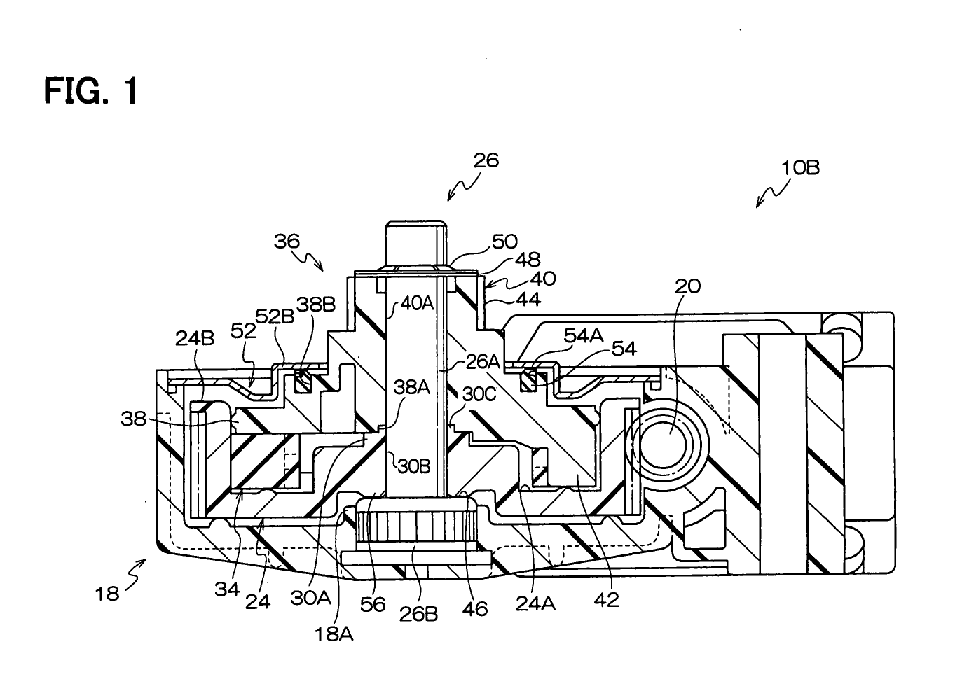

A geared electric motor (hereinafter, simply referred to as “geared motor”) 10 according to a first embodiment of the present invention will be described with reference to FIGS. 1 to 4.

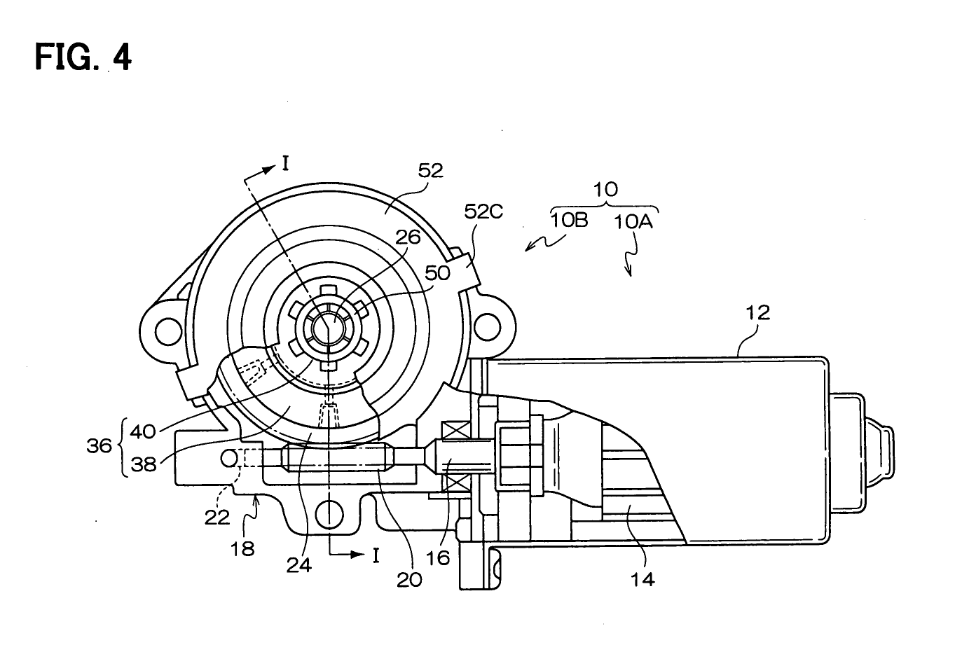

As shown in FIG. 4, the geared motor 10 includes a motor unit 10A and a speed reducing unit 10B, which are connected together. One end portion of an armature shaft 16 (rotatable shaft) of an armature 14 is rotatably supported by a bearing (not shown) in an interior of a yoke 12 of the motor unit 10A.

A distal end portion of the armature shaft 16 extends into an interior of a gear housing 18 of the speed reducing unit 10B that is connected to the yoke 12. Glass-fiber reinforced resin, which is an example of resin that improves the strength of the gear housing 18, is used as the material of the gear housing 18.

In the speed reducing unit 10B, a worm 20 is connected to the armature shaft 16. A distal end portion of the worm 20 is supported by the gear housing 18 through a bearing 22.

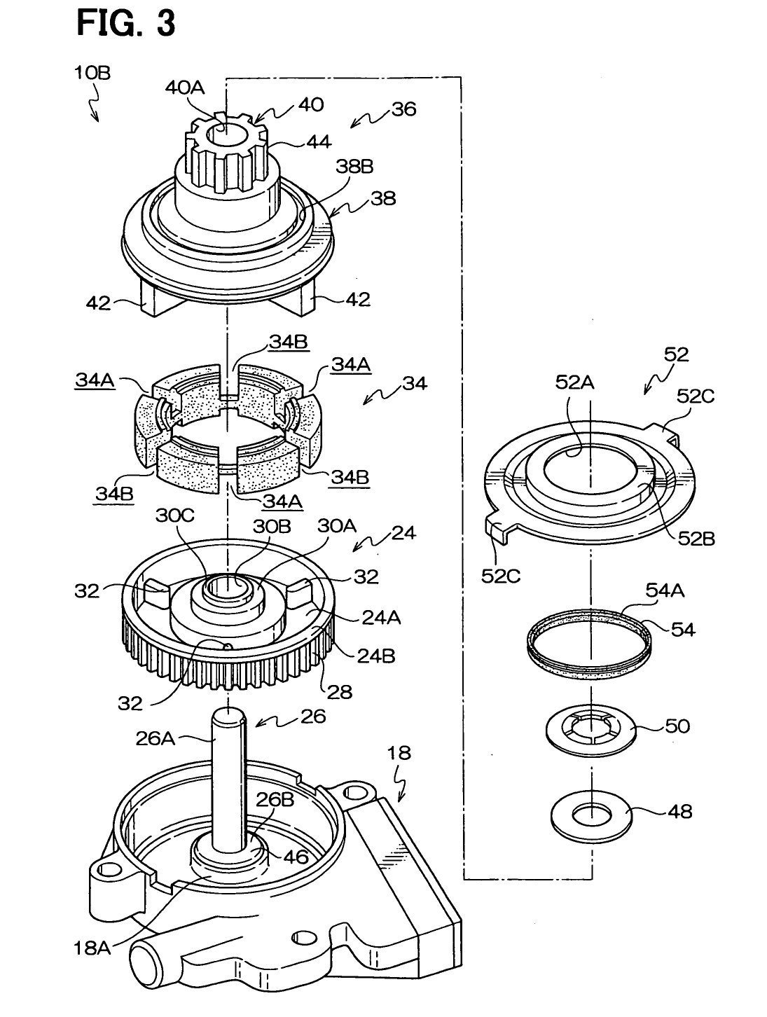

As shown in FIG. 3, the gear housing 18 is configured generally into a cup-shape to receive the worm 20 (FIG. 4) and a resin worm wheel 24, which are meshed with each other. A base end portion of a metal center shaft (serving as a support shaft) 26 is fixed to a protrusion 18A, which protrudes at a center of a bottom portion of the gear housing 18.

Specifically, the center shaft 26 rotatably supports the worm wheel 24 and includes a shaft portion 26A and a boss portion 26B. The shaft portion 26A extends in a direction that is generally perpendicular to an axial direction of the armature shaft 16 (FIG. 4). The boss portion 26B has an outer diameter, which is larger than that of the shaft portion 26A. The boss portion 26B is received in a recess formed in the protrusion 18A of the gear housing 18, so that the center shaft 26 is fixed to the gear housing 18.

Furthermore, a top surface (a worm wheel 24 side surface) of the boss portion 26B is exposed from the protrusion 18A and forms a slidably engaging surface 46, which slidably engages the worm wheel 24 that is rotated upon energization of the motor unit 10A.

The slidably engaging surface 46 of the boss portion 26B will be described in detail latter.

The worm 24 is configured generally into a cup shape and includes a bottom portion 24A and a cylindrical portion 24B. A gear 28, which is meshed with the worm 20, is formed in an outer peripheral surface of the cylindrical portion 24B.

In the worm wheel 24, a center part of the bottom portion 24A axially protrudes and has a thickened wall to form a support boss portion 30A. A shaft hole 30B is formed in the support boss portion 30A. The shaft hole 30B has an inner diameter, which is generally the same as an outer diameter of the center shaft 26, so that an inner peripheral surface of the shaft hole 30B is slidably engageable with an outer peripheral surface of the center shaft 26.

Furthermore, a generally cylindrical protrusion 30C is formed at one end surface of the support boss portion 30A such that an inner peripheral surface of the generally cylindrical protrusion 30C extends continuously from the inner peripheral surface of the shaft hole 30B. In this way, the worm wheel 24 is rotatably (slidably) supported such that the center shaft 26 is received into the shaft hole 30B while the slidably engaging surface 46 of the boss portion 26B of the center shaft 26 contacts the other end surface of the boss portion 30A. The gear 28, which is formed in the outer peripheral surface of the cylindrical portion 24B, is meshed with the worm 20.

Furthermore, a plurality (three in this embodiment) of engaging projections 32 is provided in the bottom portion 24A of the worm wheel 24 such that the engaging projections 32 are arranged one after another at generally equal intervals in a circumferential direction at a location adjacent to an inner peripheral surface of the cylindrical portion 24B.

Furthermore, a cushion rubber 34 is placed in the interior of the worm wheel 24. The cushion rubber 34 is configured into a generally cylindrical short body, and a plurality (a total of six in this embodiment) of slits 34A, 34B is formed in a peripheral wall of the cushion rubber 34 such that the slits (three slits in this embodiment) 34A and the slits (three slits in this embodiment) 34B are alternately arranged one after another at generally equal intervals in the circumferential direction. The cushion rubber 34 is inserted over the bottom portion 24A at radially inward of the cylindrical portion 24B of the worm wheel 24 while the engaging projections 32 of the worm wheel 24 are received in the slits 34A of the cushion rubber 34.

Furthermore, the speed reducing unit 10B includes a resin output shaft 36. The output shaft 36 includes a transmission plate portion 38 and an output gear portion 40. The transmission plate portion 38 receives the rotational force from the cushion rubber 34, and the output gear 40 transmits the received rotational force to the outside of the geared motor 10.

The transmission plate portion 38 is configured into a stepped disk body, a radial wall thickness of which changes in a stepwise manner. An annular recess 38B is formed on a surface (i.e., a surface that faces upward in FIG. 3) of the transmission plate portion 38 to receive a seal member 54 described latter.

A step portion 38A (FIG. 1) and a plurality (three in this embodiment) of engaging pieces 42 are formed in a rear surface (i.e., a surface that faces downward in FIG. 3) of the transmission plate portion 38. The generally cylindrical protrusion 30C of the worm wheel 24 is fitted to the step 38A of the transmission plate portion 38, and the engaging pieces 42 are formed to correspond with the slits 34B of the cushion rubber 34.

The transmission plate 38 is placed on the cushion rubber 34 at radially inward of the cylindrical portion 24B of the worm wheel 24 while the engaging pieces 42 are received in the slits 34B of the cushion rubber 34 (see FIG. 1). In this way, the rotation of the worm wheel 24 is transmitted to the transmission plate portion 38 through the engaging projections 32 of the worm wheel 24 and the cushion rubber 34.

The output gear portion 40 is formed into a generally cylindrical body and has teeth 44 and a support hole 40A. The teeth 44 are arranged one after another along an outer peripheral surface of the outer gear portion 40. An inner diameter of support hole 40A of the output gear portion 40 is generally the same as an outer diameter of the center shaft 26, so that an inner peripheral surface of the support hole 40A is slidable relative to the outer peripheral surface of the center shaft 26.

Furthermore, a lock washer 50 is fitted to the center shaft 26 at the other end portion side of the output gear portion 40 through a resin washer 48, which is provided for the purpose of limiting or alleviating the slide noise. Thereby, unintentional removal of the worm wheel 24 and the output shaft 36 from the center shaft 26 is limited.

In this state, a cover plate 52 is installed to the opening of the gear housing 18. The cover plate 52 is configured into a generally annular disk body and has an output hole 52A and a short cylindrical portion 52B. The output hole 52A is formed in the center of the cover plate 52 and has an inner diameter larger than an outer diameter of the output gear 40. The short cylindrical portion 52B is provided radially outward of the output hole 52A and is formed in conformity with the step of the transmission plate portion 38.

Furthermore, two holding portions 52C are provided in the cover plate 52. When the holding portions 52C are bent against the corresponding outer peripheral parts of the gear housing 18, the cover plate 52 is fitted to and is held by the inner peripheral surface of the upper end portion of the opening of the gear housing 18.

Furthermore, the seal member 54 is provided between the cover plate 52 and the transmission plate portion 38 to limit intrusion of, for example, water into the interior of the gear housing 18 through the gap between the cover plate 52 and the output shaft 36.

The seal member 54 includes a lip portion 54A, which is compressed against the cover plate 52. As shown in FIG. 1, in the state where the seal member 54 is fitted into the recess 38B of the transmission plate portion 38, the lip portion 54A is compressed against the cover plate 52 to limit the intrusion of the water from the outside.

A lubricant material (e.g., grease oil) is applied to the sliding portions located between the center shaft 26 and the shaft hole 30B of the worm wheel 24 as well as the support hole 40A of the output shaft 36 (the output gear portion 40) and is also applied around the seal member 54 to enable the smooth sliding movement thereof.

Next, the operation of the present embodiment will be described.

As shown in FIG. 4, in the geared motor 10, when the motor unit 10A is energized to rotate the armature shaft 16, the worm wheel 24, which is meshed with the worm 20 connected to the armature shaft 16, is rotated about the center shaft 26 while making the slide contact with the slidably engaging surface 46 (see FIG. 1) of the boss portion 26B. In this way, the rotational speed of the armature shaft 6 is reduced.

As shown in FIGS. 1 and 3, the rotational force of the worm wheel 24 is transmitted to the cushion rubber 34 through the engaging projections 32, which are fitted into the slits 34A of the cushion rubber 34. Furthermore, the rotational force of the cushion rubber 34 is transmitted to the transmission plate portion 38 through the engaging pieces 42, which are fitted into the slits 34B of the cushion rubber 34. In this way, the output gear portion 40 is rotated to drive an external mating system (e.g., a window regulator), which is connected to the geared motor 10.

Next, the slidably engaging surface 46 of the boss portion 26B will be described in detail.

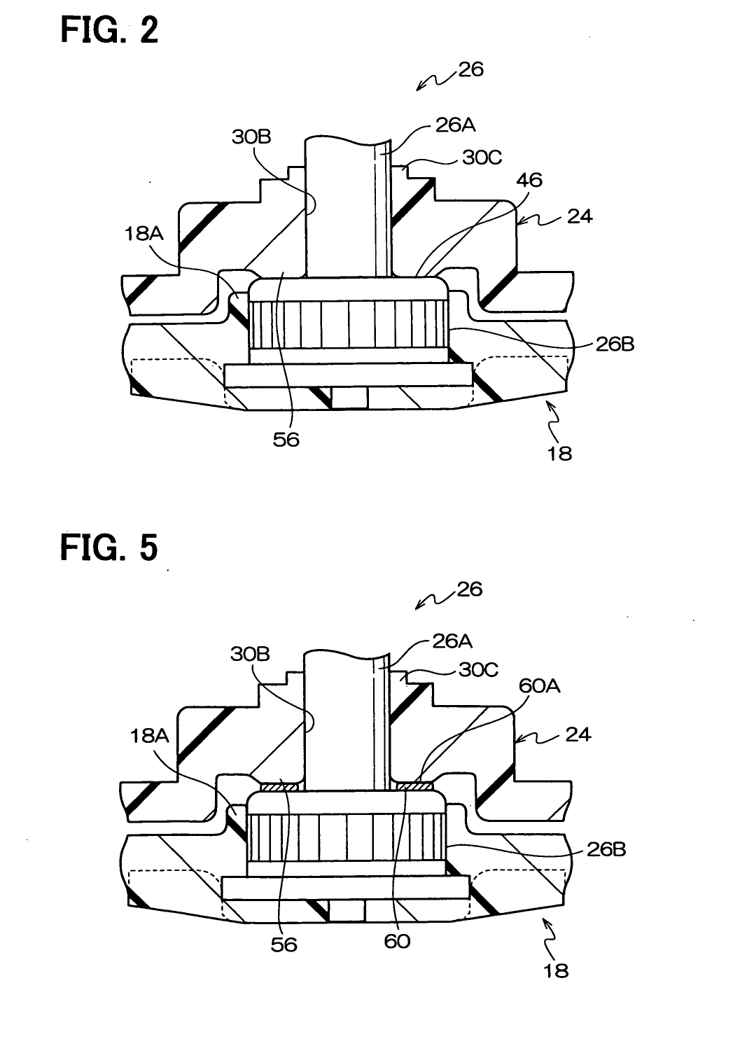

As shown in FIGS. 1 and 2, the boss portion 26B of the center shaft 26 is buried in and anchored in the protrusion 18A of the gear housing 18, and only the slidably engaging surface 46, which is provided in the top surface of the boss portion 26B, is substantially exposed from the protrusion 18A.

Furthermore, the slidably engaging surface 46 is formed as the planar surface, which faces in the axial direction of the center shaft 26, i.e., which is generally perpendicular to the axial direction of the center shaft 26. The slidably engaging surface 46 is engaged with an annular engaging portion 56, which is provided in the worm wheel 24 and projects downward in FIG. 1. The engaging portion 56 of the worm wheel 24, which is rotated upon the energization of the motor unit 10A, slidably engages the slidably engaging surface 46.

That is, the worm wheel 24 is rotated such that the engaging portion 56 of the worm wheel 24 slidably engages the slidably engaging surface 46, which is made of the metal and is provided in the metal boss portion 26B.

As described above, the gear housing 18 is molded from the resin, which includes the glass fibers. Therefore, if the rotating worm wheel 24 is slidably engaging the gear housing 18, the resin worm wheel 24 may possibly be rasped with the glass fibers contained in the gear housing 18, thereby resulting in the wearing of the worm wheel 24.

Here, as discussed above, the worm wheel 24 is rotated while the engaging portion 56 slidably engages the slidably engaging surface 46 made of the metal. Therefore, in comparison to the case where the worm wheel 24 is rotated while the worm wheel 24 being slidably engaged with the gear housing 18, it is possible to limit the wearing of the worm wheel 24 according to the present embodiment.

Furthermore, as discussed above, the slidably engaging surface 46, which is provided in the boss portion 26B, faces the axial direction of the center shaft 26. Thus, the axial positioning of the worm wheel 24 can be eased, and the slidably engaging surface 46 can be easily formed.

Furthermore, the boss portion 26B is substantially buried in the gear housing 18 except the slidably engaging surface 46. Therefore, the boss portion 26B can be securely fixed to the gear housing 18.

### Second Embodiment

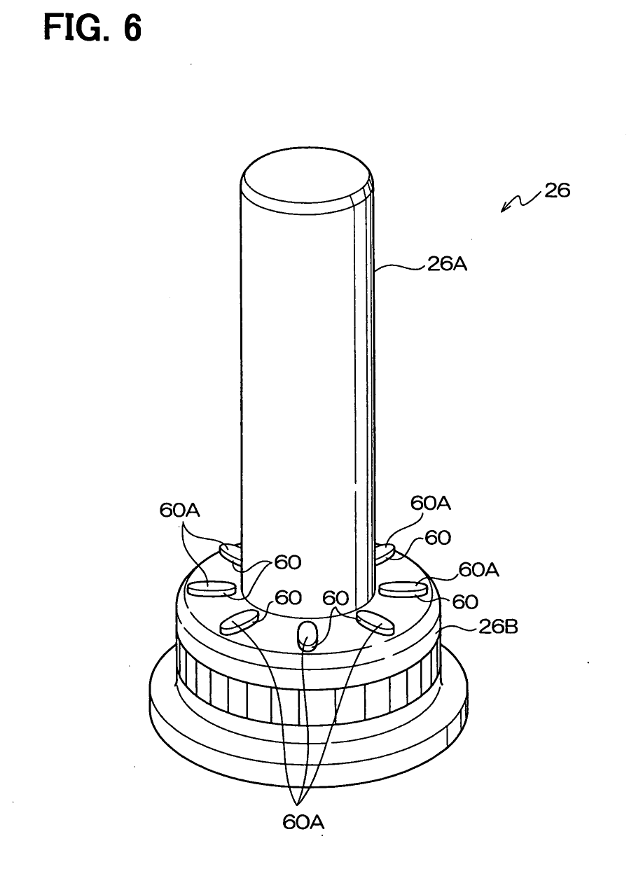

Next, a geared motor 10 according to a second embodiment of the present invention will be described with reference to FIGS. 5 and 6.

In the following description, components similar to those of the first embodiment will be indicated by the same reference numerals and will not be described further.

As shown in FIGS. 5 and 6, unlike the first embodiment, the top surface of the boss portion 26B is not the smooth planar surface. Instead, a plurality of elliptic projections 60 is provided on the top surface of the boss portion 26B such that the elliptic projections 60 axially project from the top surface of the boss portion 26B and radially extend in the normal direction in the plane of the top surface of the boss portion 26B. The elliptic projections 60 are arranged one after another in the circumferential direction generally at equal intervals. Furthermore, top surfaces of the projections 60 form slidably engaging surfaces 60A.

In the case where the slidably engaging surfaces 60A project from, i.e., are elevated from the top surface of the boss portion 26B, the axial position of the worm wheel 24 can be easily adjusted by adjusting or tuning the slidably engaging surfaces 60A.

Additional advantages and modifications will readily occur to those skilled in the art. The invention in its broader terms is therefore not limited to the specific details, representative apparatus, and illustrative examples shown and described.

What is claimed is:

1. A geared electric motor comprising:
an armature that has a rotatable shaft, which is rotated upon energization of the armature;
a worm that is connected to the rotatable shaft;
a housing that is made of resin and receives the worm;
a worm wheel that is made of resin and is received in the housing to mesh with the worm; and
a support shaft that includes:
a shaft portion that rotatably supports the worm wheel; and
a boss portion that is made of metal and is fixed to the housing, wherein the boss portion holds the shaft portion and includes a slidably engaging surface that slidably engages the worm wheel.

2. The geared electric motor according to claim 1, wherein:
the boss portion has an outer diameter that is larger than an outer diameter of the shaft portion; and
the slidably engaging surface of the boss portion faces in an axial direction of the shaft portion.

3. The geared electric motor according to claim 1, wherein the boss portion is buried in and is secured by the housing.

4. The geared electric motor according to claim 3, wherein only the slidably engaging surface of the boss portion is substantially exposed from the housing while the rest of the boss portion is substantially buried in the housing.

5. The geared electric motor according to claim 1, wherein the slidably engaging surface is formed on a projection that axially projects from the boss portion.

6. The geared electric motor according to claim 5, wherein:
the slidably engaging surface is one of a plurality of slidably engaging surfaces of the boss portion;
the projection is one of a plurality of projections, which axially project from the boss portion and are arranged one after another at generally equal intervals in a circumferential direction of the boss portion; and
each of the plurality of projections has a corresponding one of the plurality of slidably engaging surfaces.
